(19) United States
(12) Patent Application Publication
(10) Pub. No.: US 2009/0230894 A1
(43) Pub. Date: Sep. 17, 2009

(54) LIGHTING SYSTEM WITH LINKED GROUPS

(75) Inventors: Linda De Goederen, Best (NL); Dennis Van De Meulenhof, Helmond (NL); Jelle Polstra, Eindhoven (NL); Ian Mc Clelland, Waalre (NL); Walter Willaert, Eindhoven (NL); Paul Thursfield, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., EINDHOVEN (NL)

(21) Appl. No.: 12/300,188

(22) PCT Filed: May 2, 2007
(86) PCT No.: PCT/IB07/51638

§ 371 Date: Nov. 10, 2008

(30) Foreign Application Priority Data
May 11, 2006 (EP) 06113807.9

(51) Int. Cl. H05B 37/00

(52) U.S. Cl. 315/314; 315/313

(57) ABSTRACT

A lighting system (100) includes a lighting module (110) configured to accept a light source, and a controller (120) configured to be linkable to the lighting module (110). A link between the controller (120) and lighting module (110) is establishable by exchanging between the controller (120) and lighting module (110) at least one of a module link identity of the lighting module and a controller link identity of the controller. The link may be establishable based on a gesture including pointing the controller (120) to the lighting module (110), touching the controller (120) to the lighting module (110), and/or selecting the lighting module (110) from a display.

The present invention relates to lighting systems and methods for linking and to re-circuiting light groups for control by one or more remote controllers.

Innovative lighting control systems are being introduced in both the professional and consumer markets. These systems bring all the surrounding lights (inside and outside) under control, such as for dimming, switching and color adjustments in order to enrich life in terms of productivity, safety, efficiency and relaxation. Key in these systems is the possibility to “virtually” re-circuit the existing lighting. In other words, to make your own groups of lights independent of the original installed system and assign specific behavior to these groups (e.g., dinner setting).

“Virtual re-circuiting” (i.e., installing and maintaining) the lighting system is key in most innovative lighting control systems. However, most state of the art systems fail to allow for virtual re-circuiting from a user's point of view. In other words, it is difficult to install and maintain such systems, particularly when new lighting is added to existing lighting. Further, conventional lighting systems fail at the aspect of matching the human mental model of grouping lights for better control thereof. Most currently in the market available lighting control systems already fail during the re-circuiting.

Accordingly there is a need for better lighting control, virtual re-circuiting, and grouping of lights. Thus, one object of the present system and method is to provide lighting controls that allows for virtual re-circuiting and grouping of lights.

This and other objects are achieved by systems and methods that include a linking mechanism to link individual components (e.g. lamps, switches) of such a system by means of gestures like touch, proximity, pointing and/or the like, as well as to implements a mental model that allows users to use grouping of lights in daily routines via a group-identity mechanism.

Illustratively, a lighting module is provided which is configured to accept a light source, and a controller which is configured to be linkable to the lighting module. A link between the controller and lighting module is establishable by exchanging between the controller and lighting module at least one of a module link identity of the lighting module and a controller link identity of the controller. The link may be establishable based on a gesture including pointing the controller to the lighting module, touching the controller to the lighting module, bringing the controller and the lighting module in close proximity to each other, activating one or more buttons on one or both the controller to the lighting module, simultaneously or in a predetermined sequence, and/or selecting the lighting module from a display.

Further areas of applicability of the present systems and methods will become apparent from the detailed description provided hereinafter. It should be understood that the detailed description and specific examples, while indicating exemplary embodiments of the systems and methods, are intended for purposes of illustration only and are not intended to limit the scope of the invention.

These and other features, aspects, and advantages of the apparatus, systems and methods of the present invention will become better understood from the following description, appended claims, and accompanying drawing where:

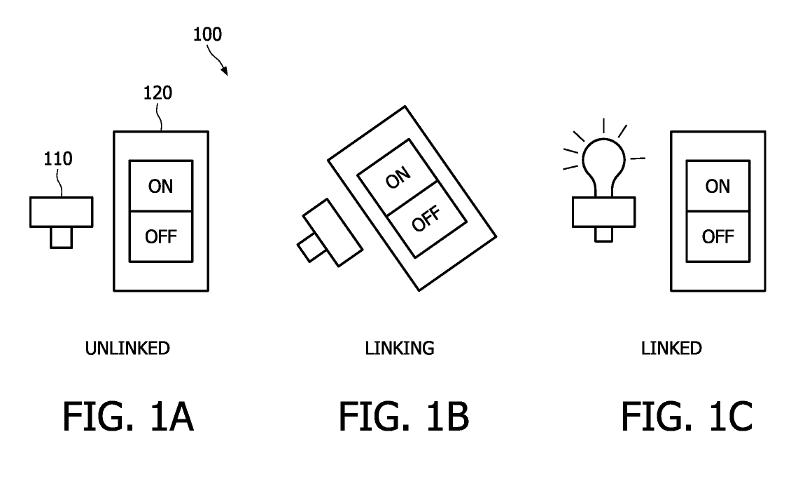

FIGS. 1A, 1B, 1C show a one embodiment including a linking mechanism;

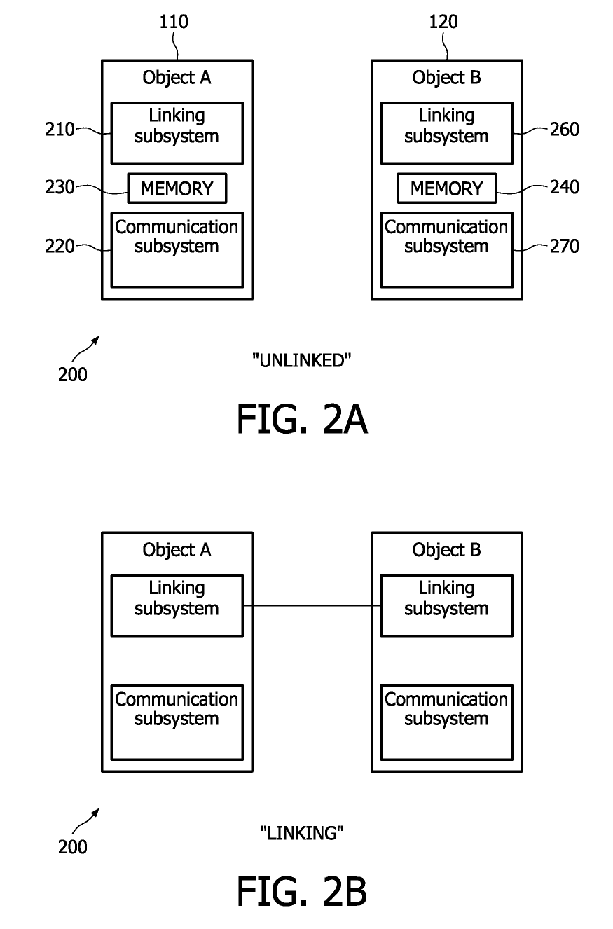

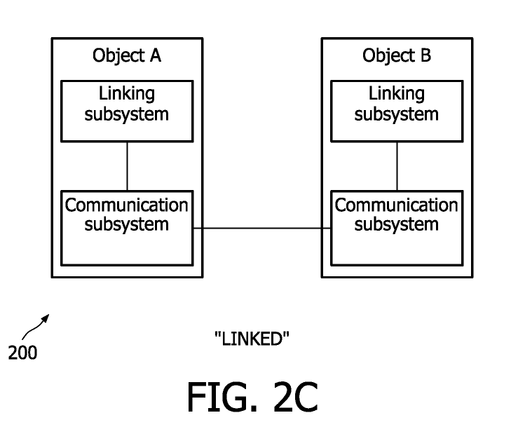

FIGS. 2A-2C show a detailed linking system; and

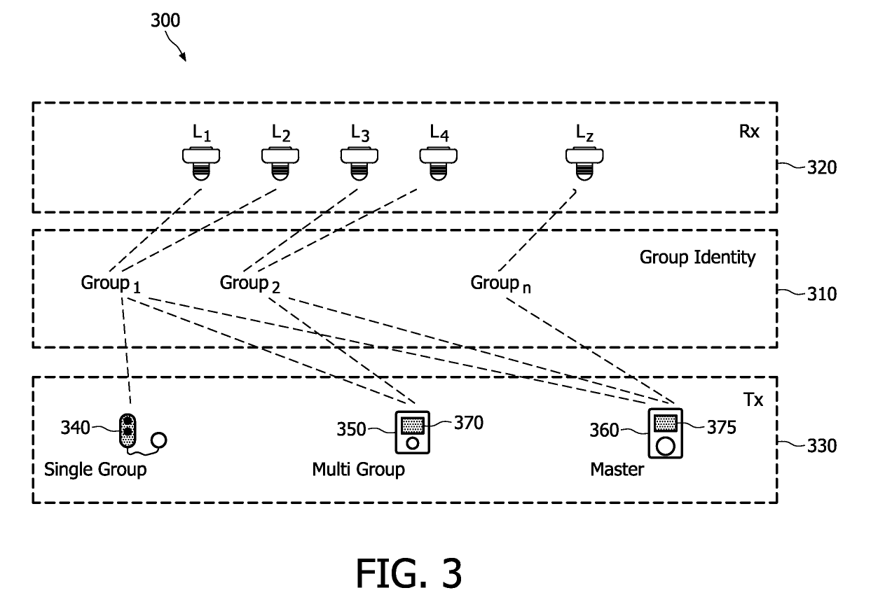

FIGS. 3A-3C show a detailed grouping system.

The following description of certain exemplary embodiment(s) is merely exemplary in nature and is in no way intended to limit the invention, its application, or uses. In the following detailed description of embodiments of the present systems and methods, reference is made to the accompanying drawings which form a part hereof, and in which are shown by way of illustration specific embodiments in which the described systems and methods may be practiced. These embodiments are described in sufficient detail to enable those skilled in the art to practice the presently disclosed system and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices, circuits, and methods are omitted so as not to obscure the description of the present system.

The present systems and methods allow for simple linking and grouping of a luminaire or light fixture housing a light source and light units, as well as linking and grouping controllers thereof. For example, assume a system with multiple light units and one or more remote controllers that may be configured to control the light units. Illustratively, the light unit is screwed into a fitting that normally accepts a light bulb, and the light bulb is screwed into the light unit. Thus, the light unit is installed between the fitting and the bulb. It is desirable for a user to know which remote controller controls which light unit, how to group lights/light units together, and which light units belong to which light group. Further, it is desirable that no other light units are included in the group controlled by a particular remote controller, (e.g. the neighbors light units). It is further desirable to know and assure that other remote controllers (e.g., the neighbor's) do not control particular light units.

Most conventional systems are pre-commissioned lighting systems where groups of lights are predefined and controlled by predefined switches. Other conventional systems include physically addressing each system component before installing the system (either using buttons pushes during an installation phase or using a color schemes to set a “House” code and a “Unit” code). However, such conventional systems do not solve the real issue for the user in a later stage when to re-group the lights is desired, or when it is desired to add a new controller or new light fixtures/luminaires/units to the system. Conventional systems also fail at the aspect of matching the human mental model of grouping lights and controllers.

Humans are used to control their current lighting systems via wall switches or directly at the luminaire/light fixture. The actual decision of light control point is done for the user without the user's involvement, e.g. by the architect of the building or the manufacture of the luminaires Humans get use to these “precooked” metal models but when confronted with the freedom of re-circuiting their home lighting to their needs, they realize how uncomfortable these current solutions are with respect to their daily routines. For example, to get a cozy light setting in the living room, several lights at different physical locations within the room have to be set at specific light intensities. In most cases, this routine of setting such a cozy environment is repeated frequently (sometime even every evening). Similar patterns can be identified for other routines e.g., ‘coming home’, ‘going to bed’, ‘having diner’, etc. By allowing to group and re-group lights and controllers, a mental model is implemented that allows users to use grouping of lights in daily routines via a group-identity mechanism.

FIGS. 1A-1C show a lighting system 100 according to one embodiment including a light unit 110 that communicates with a controller 120, such as a switch or a remote controller. The communication may be via any means, wired or wireless. The light unit 110 may be of the type that attaches to, such as a unit that screws into, a light socket and accepts a light bulb.

In addition to the communication mechanism, a linking mechanism is provided that establishes a link between the light unit 110 and the remote control or controller 120. The user links the light unit(s) 110 with the remote control(s) 120, which may be changed such as re-linked and re-grouped as desired, where setting (e.g., dinner, reading, TV watching, romantic settings and the like) may be pre-determined/programmed/programmable by the user and stored in a memory, such as the memory of the remote control(s) or a system controller.

In one embodiment, a physical gesture is used to interact and change the system, including re-linking and re-grouping lights with controllers, and programming settings, which may be implemented, activated and/or predetermined at any time and applied in several stages, starting at the point of sale via the first installation in the home up to extension and re-configuration of the lighting system in a later stage.

Illustratively, the gesture includes at least one of pointing a controller 120 shown in FIGS. 1A-1C to a lighting module 110, touching the controller 120 to the lighting module, and/or selecting the lighting module 120 or lights source from a display, such as a touch sensitive display 370, 375 of a multi-group and/or master controller 350, 360 shown in FIG. 3. A laser including a visible indication, such as a laser pointer included in the controller may also be used to point a light module and then select it for control and/or grouping with other light modules. Other gestures may include bringing the controller and the lighting module in close proximity to each other, and/or activating one or more buttons on one or both the controller to the lighting module, simultaneously or in a predetermined sequence, for example. The controllers may be dedicated controllers or integrated devices, such as mobile or cell phones, personal digital assistance (PDA), multimedia (e.g., TV/radio/playback unit) controllers, laptop or personal computer and the like.

Illustratively, a map and/or menu of the light sources may be displayed on the screen(s) 370, 375, where the light sources may be grouped together as desired and associated desired controllers. Further, desired settings may be associated with the selected light(s) and/or group(s), such as ‘coming home’, ‘going to bed’, ‘having diner’, ‘romantic’, ‘reading’ settings and the like. Of course, the settings (and the grouping) may be programmable and/or predetermined and may be stored in a memory 230 of the controller 110 and/or memory 240 of the light unit 120, shown in FIG. 2A. By allowing to group and re-group lights and controllers, a mental model is implemented that allows users to use grouping of lights in daily routines via a group-identity mechanism.

FIGS. 1A, 1B, 1C show a linking mechanism including three sequential states: “unlinked”, “linking” and “linked” objects such as the light unit 110 and the remote control 120.

The first step shown in FIG. 1A may be referred as “unlinked”. The objects are unlinked and are not aware of each others (note that this means that these objects cannot communicate). The second step shown in FIG. 1B may be referred as “linking”. In this step, the objects are exchanging their identity so that they are aware of each others. The third step shown in FIG. 1C may be referred as “linked”. After being installed, the objects establish a link using communication mechanism, wired or wireless, based on the awareness of each others. Any selection means may be used to establish the link, such as by issuing link commands and/or queries using input/output devices such as keyboards, mice, pointing on a touch screen, pushing a button etc.

FIGS. 2A-2C show detailed linking systems 200. Assume the same system as shown in FIGS. 1A-1C, where the lamp units are object A and the remote controls 120 are object B, or vice verse. As shown in FIGS. 2A-2C, these objects 110, 120 each include a linking sub-system 210, 260 to discover each other and a communication subsystem 220, 270 to setup the actual communication link for further communication.

In the “Unlinked”-phase shown in FIG. 2A, both objects 110, 120 are not aware of each other and not linked. As objects 110, 120 are not linked, no communication can take place between the objects 110, 120. In fact, they don't know each others communication subsystem identifier, the so-called CommId. In the “Linking”-phase shown in FIG. 2B, both objects 110, 120 exchange theirs linking subsystem identifier, the so-called LinkId. As a result, the linking subsystem 210 of Object A 110 is aware of Object B 120 and vice versa. It should be noted that it is enough for only one object to provide its LinkId with the result that only one of the objects is aware of the other.

In the “Linked”-phase shown in FIG. 2C, the objects 110, 120 exchange their CommIds based on their LinkIds. For example, the communication subsystem 220 queries the linking subsystem 210 for the new LinkId. Illustratively, the communication subsystem 220 of object A 110 queries the linking subsystem 210 of its object A 110. In response, object A's linking subsystem 210 provide its object A's communication subsystem 220 with the LinkId B of object B 120 received (from object B 120) during the linking stage (FIG. 2B). Similarly, the linking subsystem 260 of object B 120 will provide LinkId A of object A 110 (received from object A 110 during the linking stage) in response to a query from the communication subsystem 270 of Object B 120 itself.

At the communication subsystem level 220, these LinkId will be exchanged and corresponding CommId will be provided which establishes the final link. For example, suppose Object A 110 queries via the communication channel for the CommId of devices with LinkId B. Obviously, only Object B will respond with its CommId B. Of course, also Object B might have taken the lead by asking this question.

Illustratively, the lighting control system 100 includes light units 110 having different physical manifestations, such as screw-in bulb adaptor, intelligent bulbs such as chip in a bulb or bulb adapter, wall socket, etc. Similarly, the controller 120 may be various types of remote controls such as key fobs, multi group controller, sensors, etc. With respect to the communication subsystem 220, various means may be used, wired or wireless, such as a “now new wires”-technology, e.g. Zigbee, Z-wave, X10, or other wireless protocols including the short range Bluetooth protocol. For the linking subsystem 210, a “short range proximity”-technology may be used, e.g., infrared, tagnology (using tags such as RFID tags and tag readers), pointing, sonar, laser, etc. Initially, the lighting control system 100 may be used to create one's own “virtual” re-circuiting lighting control system that includes groups of light units along with their associated specific behavior which may be predetermined or programmable by the user, such as to provide light with desired attributes including desired intensity, color, hue, saturation, color mixture and control, color temperature control, light beam width and direction and the like.

Further extensions include adding new light unit(s) and remote control(s) to the system. For example, holding a “new virgin” key fob to an already used key fob will copy the setting of the existing controller or key fob. In the same way, a sensor might be “programmed”. Of course, the entire setting or only a partial, e.g., selected, setting of one controller (e.g., key fob) may be copied into a new controller or key fob, as desired. Several predetermined and programmable defaults may be set, such as copying the latest setting and the like.

The lighting system may be used to backup or transfer the established link information. For example, holding a key fob or any other remote control close to a multi group remote controller allows the latter to learn about the group of lights associated with or controlled by the key fob. Of course, the lighting system may be easily re-configured. For example, unlinking a light unit might be established by linking it to other remote control unit.

In addition to the described linking and communication mechanism, a group identify mechanism may be provided. Such a group identify mechanism offers the users a simple group identity based system with a coherent mental model. Illustratively, a group identity is used as a reference. Assume the lighting system is split into transmitter (Tx) and receiver (Rx) modules. The Tx-modules (e.g., key fobs, sensors, wall switch, multi group controller and master controller) issue commands to the Rx modules (e.g., screw-in bulb unit, bulb, socket unit) based on a group association, the so-called group identify. The commands for example may be simple behavior like ON/OFF/DIM, or more complex behavior like scene setting (e.g., ON/OFF/DIM of an individual light of a group), such as romantic, reading, TV watching settings and the like. The proposed solution assumes that each single Rx-module is linked to one and only one group identity.

Illustratively, the Tx-modules may be hierarchically organized by increased complexity as follows:

Level 1 Tx-modules may be associated to one and only one group identity and are configured to issue, exhibit and control a simple behavior (e.g., ON/OFF/DIM) to this group. Examples of Level 1 Tx-modules include key fobs, sensors, wall switches, etc.

Level 2 Tx-modules may be associated to one or more group identities and are also configured to issue, exhibit and control simple behavior (e.g., ON/OFF/DIM) to this group. An example of Level 2 Tx-modules includes multi-group controllers.

Level 3 Tx-modules may be associated to one or more group identities and are configured to issue, exhibit and control more complex behavior (e.g., scene settings) to groups and individual Rx-modules. A master controller is one example of a Level 3 Tx-module.

Similarly, such a hierarchy may be provided for the Rx-modules (e.g., ranging from single light sources to multiple light sources and/or from single color sources to multiple color sources).

As described in connection with FIGS. 2A-2C, a lighting system includes the communication subsystem 220 (for establishing communication between the nodes), and the linking subsystem 210 (linking Rx- and Tx modules 320, 330 shown in FIG. 3). The lighting system may be a hierarchically organized structure as described. In particular, a Single Group Controller (SGC) is included in, or classified as, a level 1 Tx-module, a Multi Group Controller (MGC) is included in or, classified as, a level 2 Tx-module. Further, a Master Controller (MC) may be a level 3 Tx-module.

FIG. 3 shows a lighting control system 300 configured in accordance with the group identity which extends the lighting control system. The group identity may be implemented as a database management system, e.g., distributed, the so-called Group Identity subsystem 310. One task of the Group Identity subsystem 310 includes managing (e.g., adding new unique Group Identities and remove obsolete Group Identities, add/delete Rx-modules 320 and Tx-modules 330, etc.) the list of associations between Rx- and Tx-modules 320, 330 in the system 300. Illustratively, a unique Group Identity is created based on a combination of LinkId, CommId and the SessionId. For example, the SessionId represents the instance of the actual association, e.g., using wrapped around increasing numbers, where each session has a unique ID which is increasing as sessions end and new sessions begin.

Suppose no association exists between the Rx- and Tx-modules 320, 330 of the system 300. Thus no Group Identity is assigned yet. Once the SGC 310 is linked to light source L1, Group 1 is created out-of the LinkId, CommId and SessionId. Note that the SessionId is increased each next time that both modules are linked assuring the uniqueness of the SessionId. Both light source L1 and the SGC 310 are configured to store this unique group identity. Subsequently, L2 is associated to the same group after being linked to the SGC 310 and will also store Group 1. Note that no new Group Identity has to be created since Group 1 is still valid. A simple check can be performed asking “who is still associated to Group 1”. Group 2 is created similarly where L3 and L4 are associated to the MGC. Now the lighting system 300 includes two groups. By linking the SGC to the MGC, the MGC will learn the group identity of the SGC (thus storing Group 1 as well). Group z is created by linking Lz to the MC.

The lighting control system may include light units in different physical manifestations (e.g. screw-in bulb adaptor, bulb, wall socket, etc.) and remote controls (e.g., key fobs, multi group controller, sensors, etc.). Further, various communication subsystem or protocols may be used, such as “now new wires”-technology, e.g. Zigbee, Z-wave, X10, etc. With respect to the linking subsystem, a “short range proximity”-technology may be used, e.g., Bluetooth, infrared, tagnology, pointing, etc. A simple database, which may be distributed, is useable to implement the group identity subsystem. Of course, communication and/or linking may be established based on wired systems also, in addition to or in lieu of wireless systems.

Illustratively, the power behavior of the communication systems in relation to the distribution of the database over the physical system components may be taken into account. For example, one might tune the distributed database synchronization between wired and wireless component assuming that, for power consumption reasons, wireless component might ‘sleep’ and ‘wake-up’ periodically or when needed.

Of course, as it would be apparent to one skilled in the art of communication in view of the present description, various elements may be included in the controller and/or light units, such as one or more transmitters, receivers, or transceivers, antennas, modulators, demodulators, converters, duplexers, filters, multiplexers etc., which will not be further described in order not to obscure description of the present system and method. The controller(s) and/or the light unit(s) may include a processor and/or a memory, where the processor executes instruction stored in the memory, for example, which may also store other data, such as predetermined or programmable setting related to control of the light sources, including programmable grouping of lights and light attributes/settings, such as intensity (i.e., dimming function), color, hue, saturation, beam width, direction, color temperature, mixed colors, and the like, for the case of light source that may be controlled to change attributes of light emanating therefrom. Of course, the desired color attributes may be the same or different for groups or for lighting units within one group. That is, individual light units may provide light of different desired attributes despite being in a single group. Similarly, the same light unit may belong to two or more different groups and depending on which group is being controlled, this ‘same’ light unit may provide lights of different attributes, e.g., attribute one when controlled within or with group one, and attribute two when controlled within or with group two. Of course, if there is a conflict, where both group one and two are being controlled, thus requiring this ‘same’ light to simultaneously provide different light attributes, the user may be notified, or there may be predetermined hierarchical or other structure for one attribute to take precedence over another in case of conflict.

Light emitting diodes (LEDs) are light sources that are particularly well suited to controllably provide light of varying attributes, as LEDs may easily be configured to provide light with changing colors, intensity, hue, saturation and other attributes, and typically have electronic drive circuitry for control and adjustment of the various light attributes. However, any controllable light source may be used that is capable of providing lights of various attributes, such as various intensity levels, different colors, hue, saturation and the like, such as incandescent, fluorescent, halogen, or high intensity discharge (HID) light and the like, which may have a ballast or drivers for control of the various light attributes.

It should be understood that the various component of the lighting system may be operationally coupled to each other by any type of link, including wired or wireless link(s), for example. Various modifications may also be provided as recognized by those skilled in the art in view of the description herein. The memory may be any type of device for storing application data as well as other data. The application data and other data are received by the controller or processor for configuring it to perform operation acts in accordance with the present systems and methods.

The operation acts of the present methods are particularly suited to be carried out by a computer software program, such computer software program preferably containing modules corresponding to the individual steps or acts of the methods. Such software can of course be embodied in a computer-readable medium, such as an integrated chip, a peripheral device or memory, such as the memory or other memory coupled to the processor of the controller or light module.

The computer-readable medium and/or memory may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory 230, 240.

Additional memories may also be used. The computer-readable medium, the memory 230, 240, and/or any other memories may be long-term, short-term, or a combination of long- and -short term memories. These memories configure the processor/controller to implement the methods, operational acts, and functions disclosed herein. The memories may be distributed or local and the processor, where additional processors may be provided, may be distributed or singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory, for instance, because the processor may retrieve the information from the network.

The processor of the controller and/or light module, and the memory 230, 240 may be any type of processor/controller and memory, such as those described in U.S. 2003/0057887, which is incorporated herein by reference in its entirety. The processor may be capable of providing control signals and/or performing operations in response to selecting and grouping light modules and/or selecting predetermined or programmable light settings, and executing instructions stored in the memory. The processor may be an application-specific or general-use integrated circuit(s). Further, the processor may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems.

Of course, it is to be appreciated that any one of the above embodiments or processes may be combined with one or with one or more other embodiments or processes to provide even further improvements in finding and matching users with particular personalities, and providing relevant recommendations.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

1. A lighting system comprising:
a lighting module configured to accept a light source; and
a controller configured to be link able to establish a communication link with said lighting module by exchanging between said controller and said lighting module at least one of a module link identity of said lighting module and a controller link identity of said controller, said controller comprising a laser pointer for verifying selection of said lighting module by a user prior to establishing said communication link.

2. The lighting system of claim 1, wherein establishing of said communication link is facilitated by an action by the user, the action being selected from the group consisting of: pointing said controller to said lighting module, touching said controller to said lighting module, bringing said controller and said lighting module in proximity with each other, and selecting said lighting module from a plurality of lighting modules represented on a display.

3. The lighting system of claim 1, wherein said lighting module includes a module linking subsystem, and said controller includes a controller linking subsystem; said module linking subsystem and said controller linking subsystem being configured to exchange said at least one of said module link identity and said controller link identity.

4. The lighting system of claim 1, wherein said controller is further configured to establish said communication link by exchanging between said controller and said lighting module at least one of a module command identity of said lighting module and a controller command identity of said controller.

5. The lighting system of claim 4, wherein said lighting module includes a communication subsystem, and said controller includes a controller communication subsystem; said module communication subsystem and said controller communication subsystem being configured to exchange said at least one of said module command identity and said controller command identity.

6. The lighting system of claim 1, wherein said lighting module includes a module linking subsystem and a module communication subsystem, and said controller includes a controller linking subsystem and a controller communication subsystem; said module linking subsystem and said controller linking subsystem being configured to exchange said at least one of said module link identity and said controller link identity; and said controller communication subsystem being configured to receive said module link identity from said controller linking subsystem and issue a command to control said light source when accepted in said lighting module.

7. The lighting system of claim 1, wherein said lighting module includes a module linking subsystem and a module communication subsystem, and said controller includes a controller linking subsystem and a controller communication subsystem; said module linking subsystem and said controller linking subsystem being configured to exchange said at least one of said module link identity and said controller link identity; and said module communication subsystem and said controller communication subsystem being configured to exchange at least one of a module command identity and a controller command identity.

8. (canceled)

9. The lighting system of claim 1, wherein said controller is portable.

10. The lighting system of claim 1, wherein said link is established through wireless communication.

11. (canceled)

12. The lighting system of claim 1, comprising a plurality of lighting modules, wherein said controller is configured to be linkable to at least one group of lighting modules of said plurality of lighting modules for controlling light sources associated with said at least one group.

13. The lighting system of claim 12, wherein respective groups of said at least one group have respective group identities, said controller being configured to control said respective groups based on said respective group identities.

14-18. (canceled)

19. A method of controlling a light source by a controller comprising a laser pointer, the method comprising the acts of:
selecting said lighting source by pointing said laser pointer thereon;
exchanging between said controller and said light source at least one of a source link identity of said light source and a controller link identity of said controller; and
establishing a communication link between said controller and said light source.

20. (canceled)

21. The method of claim 19, further comprising the act of exchanging between said controller and said light source at least one of a source command identity of said light source and a controller command identity of said controller.

22-23. (canceled)

24. The method of claim 19, further comprising the acts of:
linking at least one group of light sources; and
selecting one group of said at least one group for controlling respective light sources associated with said one group.

25. The method of claim 24, further comprising the acts of:
selecting a plurality of groups of said at least one group;
forming a session identity associated with said plurality of groups;
assigning a predetermined setting to said session identity; and
controlling light sources associated with said session identity in accordance with said predetermined setting.
